(19) United States
(12) Patent Application Publication
(10) Pub. No.: US 2026/0318469 A1
(43) Pub. Date: Oct. 15, 2026

(54) A CONNECTION AND SUPPORT DEVICE AND A METHOD FOR CONNECTING THE DEVICE

(71) Applicant: Monoblocc Limited, Hong Kong (CN)

(72) Inventors: Wolfgang Tobias Ettlich, Sai Ying Pun, Hong Kong (CN); Paul Gerald Whelan, New Territories, Hong Kong (CN)

(21) Appl. No.: 19/491,533

(22) PCT Filed: Jun. 11, 2024
(86) PCT No.: PCT/CN2024/098406

§ 371 Date: Dec. 9, 2025

(30) Foreign Application Priority Data
Jun. 9, 2023 (HK) 32023074330.6

(51) Int. Cl. F16M 11/16; F16M 11/04; F16M 11/20; F16M 13/02

(52) U.S. Cl. CPC F16M 11/16; F16M 11/04; F16M 11/2007; F16M 13/02

(57) ABSTRACT

A connection and support device (1), which can be regarded as a block (1) for mounting accessories (70/71/73/74) to a computer monitor (80). The monitor (80) comprises a mounting interface (80a) with screw couplings disposed in a square array. The block (1) comprises: two substantially parallel opposing surfaces (11, 12), a periphery of the block (1) extending between the two surfaces (11, 12), four first mounting apertures (41) extending in the through-thickness direction between the two surfaces (11, 12), and a plurality of like openings (23a~26c) in the periphery that are configured to receive mounting rods (61/62/63). One of the surfaces (11 or 12) is adapted to abut the mounting interface (80a). The four first mounting apertures (41) are disposed in a first square array corresponding to the square array of the screw couplings. An assembly and a method related to the block (1) are also provided.

### FIELD OF THE INVENTION

The present invention relates to a block for mounting accessories, which can also be referred as a connection and support device for connection and support of one or more external accessories to be added in close proximity to, or supported by, a computer monitor. The invention further relates to a method for connecting the device.

### BACKGROUND

With increasing prevalence of internet and personal computers, people have been adapting to new work and life styles with presence of computers. There are various kinds of configurations with computers, monitors and other accessories to set up workstations or entertainment areas. The demand for such customized setups further increases with the worldwide trends of working from home, video conferences, gaming, influencer industry, etc. However, addition and thus setup of accessories (such as lighting, audio, and camera devices) are limited in terms of versatility and degree of integration, sometimes due to default installation methods of those accessories and space limit.

Some existing device hubs, such as a device bracket disclosed in WO2009129011A1, require connectors that are proprietary for the device hubs which bring about inflexibility when trying to adapt to various connectors and external devices.

It has been found that sometimes an electrical connection may not be desired in some scenarios when using a device bracket. In addition, there is also a need for a more modular and versatile connection and support device for mounting various accessories.

### SUMMARY OF THE INVENTION

A first aspect of the invention herein relates to a block for mounting accessories to a computer monitor, the monitor comprising a mounting interface with screw couplings disposed in a square array. The block comprises substantially parallel opposing surfaces and a periphery of the block extending between the two surfaces. One of the surfaces is adapted to abut the mounting interface. The opposing surfaces are spaced apart in a through-thickness direction by a dimension defining a thickness of the block. The block comprises four first mounting apertures extending in the through-thickness direction between the two surfaces. The four first mounting apertures are disposed in a first square array corresponding to the square array of the screw couplings. The block comprises a plurality of like openings in the periphery that are configured to receive mounting rods, each opening having an axis, the axis of each opening disposed in an imaginary plane parallel to the two surfaces. The openings comprise a first pair of parallel openings for extending substantially horizontally in use, the openings of the first pair disposed adjacent one another on a first portion of the periphery. The openings comprise a second pair of parallel openings for extending substantially horizontally in use, the openings of the second pair disposed adjacent one another on a second portion of the periphery substantially opposite the first portion of the periphery. The openings comprise an orthogonal opening aligned substantially orthogonally to the first and second pairs of openings for extending substantially upwards from the block in use, the orthogonal opening disposed in an intermediate portion of the periphery, disposed between the first and second portions, and uppermost in use.

In an embodiment, the block comprises a central through-extending cavity that extends between the two surfaces such that the block has ring-like form, and each of the openings comprises an internal screw thread.

In an embodiment, the square array of the first four mounting apertures has a centre, the cavity is circular in cross-section and its axis passes through the centre, and further comprising four second mounting apertures extending in the through-thickness direction between the two surfaces, the four second mounting apertures disposed in a second square array smaller than the first square array and equidistant from the centre and angularly aligned with the four first mounting apertures.

In an embodiment, wherein the openings further comprises a pair of acutely inclined openings in the intermediate portion of the periphery, wherein the acutely inclined opening are inclined acutely to the orthogonal opening and disposed on opposite sides of the orthogonal opening, the periphery includes respective circumferential faces surrounding the circumferences of the orthogonal opening and each of the acutely inclined openings, each of the circumferential faces aligned substantially perpendicular to respective axes of the openings.

In an embodiment, wherein the intermediate portion of the periphery further comprises a respective concavity at least partially bounded by the respective circumferential faces around each of the acutely inclined openings.

A second aspect of the invention herein relates to a connection and support device containing a main body having a front surface of the main body. The main body contains a back surface of the main body, the back surface being opposite to and parallel to the front surface, and four sides. The four sides are a left side disposed between the front surface and the back surface, and where the left side is perpendicular to the front surface and the back surface, a top side disposed between the front surface and the back surface and where the top side is perpendicular to the front surface and the back surface, and where the top side is perpendicular to the left side, a right side disposed between the front surface and the back surface and perpendicular to the front surface and the back surface, and where the right side is perpendicular to the top side, a bottom side disposed between the front surface and the back surface and perpendicular to the front surface and the back surface, and where the bottom side is perpendicular to the right side. The main body contains a plurality of openings at a location selected from the group consisting of the left side, the top side, the right side, the bottom side, and a combination thereof, and each of the plurality of openings is adapted to accommodate an extension member.

In an embodiment, each opening has a bore alignment, and where the bore alignment of at least one of the plurality of openings is tilted with an angle compared with the bore alignment of at least one other opening.

In an embodiment, the location is the left side, the top side, and the right side, and where each location comprises a plurality of openings.

In an embodiment, the location further comprises a recess, and where the recess comprises an opening.

In an embodiment, the recess comprises a primary slanted portion; the primary slanted portion is arranged to be inclined from the side where the recess is located; the opening is provided on the primary slanted portion such that the bore alignment of the opening is tilted with an angle compared with the side where the recess is located.

In an embodiment, the recess includes a secondary slanted portion, where the angle between the primary slanted portion and the side where the recess is located is smaller than the angle between the secondary slanted portion and the side.

In an embodiment, the angle between the primary slanted portion and the side where the recess is located is from about 5° to about 60°, or from about 15° to about 35°, or from about 20° to about 30°, or about 21°, or about 22°, or about 23°, or about 24°, or about 25°, or about 26°, or about 27°, or about 28°, or about 29°, or about 30°.

In an embodiment, the left side comprises an opening, the right side includes an opening, and where the bore alignments of the openings are collinear.

In an embodiment, the device includes from about three to about ten openings on a side.

In an embodiment, the bore alignment of each of the openings is different.

In an embodiment, the bore alignment is adjustable.

In an embodiment, the device includes about three openings on each of the four sides, and where the bore alignment of each of the three openings on each of the four sides is different.

In an embodiment, each of the left side and the right side includes two or three openings, where the bore alignments of the two or three openings are parallel to one another.

In an embodiment, the location includes two recesses.

In an embodiment, the location is the top side.

In an embodiment, one of the two recesses is located proximal to the left side and distant from the right side and the other of the two recesses is located proximal to the right side and distant from the left side.

In an embodiment, the location is a side that comprises three openings, where one of the three openings is the middle opening located between the other two openings and oriented perpendicular to the side where it is located, and where the other two openings are oriented away from the middle opening as observed externally to the device.

In an embodiment, the device comprises a plurality of mounting holes for connecting the device with an apparatus and a support.

In an embodiment, the location is the top side and the bottom side, each of which comprises two recesses, where two recesses of the four recesses, one located at the top side and the other located at the bottom side, are proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, where the plurality of mounting holes are provided at the corner portions.

In an embodiment, the plurality of mounting holes comprises four 100 mm×100 mm spaced mounting holes and four 75 mm×75 mm spaced mounting holes, where each of the 75 mm×75 mm spaced mounting holes is located proximal to a mounting hole from the 100 mm×100 mm spaced mounting holes and is arranged in a radial direction closer to the center of the main body with respect to the 100 mm×100 mm spaced mounting hole.

In an embodiment, the location is the top side and the bottom side, each of which comprises two recesses, where the two recesses of the four recesses, one located at the top side and the other located at the bottom side, are located proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, wherein one or more mounting holes are provided at the corner portions, where the main body is substantially in form of a ring structure with the one or more corner portions attached to its outer side, where the 100 mm×100 mm spaced mounting holes are located at the corner portions and the 75 mm×75 mm spaced mounting holes are located at the ring structure.

In an embodiment, where the connection and support device includes a central cavity in the middle of the main body.

In an embodiment, the main body is substantially in form of a square prism with a length of from about 105 mm to about 150 mm, or from about 110 mm to about 120 mm, or about 110 mm, or about 115 mm, or about 120 mm, and a thickness of from about 7 mm to about 40 mm, or from about 10 mm to about 30 mm, or from about 15 mm to about 25 mm, or about 15 mm, or about 20 mm, or about 25 mm, and the central cavity is in form of a cylinder with circular bases formed on the front surface and the back surface, where the diameters of the circular bases are from about 60 mm to about 90 mm, or from about 80 mm to about 86 mm, or about 80 mm, or about 81 mm, or about 82 mm, or about 83 mm, or about 84 mm, or about 85 mm, or about 86 mm.

Another embodiment of the invention herein relates to a connection and support device containing a main body having a front surface of the main body. The main body contains a back surface of the main body, the back surface being opposite to and parallel to the front surface, and four sides. The four sides are a left side disposed between the front surface and the back surface, and where the left side is perpendicular to the front surface and the back surface, a top side disposed between the front surface and the back surface and where the top side is perpendicular to the front surface and the back surface, and where the top side is perpendicular to the left side, a right side disposed between the front surface and the back surface and perpendicular to the front surface and the back surface, and where the right side is perpendicular to the top side, a bottom side disposed between the front surface and the back surface and perpendicular to the front surface and the back surface, and where the bottom side is perpendicular to the right side. The main body contains a plurality of openings at a location selected from the group consisting of the left side, the top side, the right side, the bottom side, and a combination thereof, each of the plurality of openings is adapted to accommodate an extension member. Each opening has a bore alignment, and where the bore alignment of at least one of the plurality of openings is tilted at a different angle compared with the bore alignment of at least one other opening. The bore alignment of each of the openings is different. The bore alignment is adjustable. The location is the left side, the top side, and the right side, and where each location includes a plurality of openings. The location further includes a recess, and where the recess includes an opening. The left side includes an opening, the right side includes an opening, and where the bore alignments of the openings are collinear. The main body is in form of rectangular shape. The four sides are provided at the main body substantially perpendicular to the front surface and the back surface. The device includes a central cavity in the middle of the main body so that the front surface and the back surface are communicated through the cavity portion, and the openings are exposed in the cavity. The device includes from about three to about ten openings on a side. In particular the device includes about three openings on each of the four sides, and where the bore alignment of each of the three openings on each of the four sides is different. The middle opening of the three openings is oriented in a way perpendicular to the surface where it is located. The left and right openings of the three openings are oriented away from the middle opening as observed externally to the device.

A third aspect of the invention relates to an assembly for mounting accessories to a computer monitor, wherein the assembly comprises a block according to embodiments or the first aspect of the invention or a connection and support device according to embodiments or the second aspect of the invention. The assembly further comprises one or more mounting rods for connecting the block or the connection and support device with the accessories. The one or more mounting rods and the accessories are supported by the block or the connection and support device.

In an embodiment, the assembly further comprises a secondary hub, the secondary hub comprising a pair of first openings in parallel and a second opening. Each of the pair of first openings is aligned with respective one of the first pair or the second pair of parallel openings of the block or aligned with respective one of the openings on left or right side of the connection and support device, each of the pair of the parallel openings of the secondary hub receiving one of the mounting rods, an end of the one of the mounting rods received by the respective one of the openings of the block or the connection and support device. The second opening is for receiving another one of the mounting rods for coupling with one of the accessories.

In an embodiment, the pair of the parallel openings of the secondary hub is located at a first side of the secondary hub facing the block or the connection and support device, and the second opening of the secondary hub is located at a second side of the secondary hub, wherein first side and the second side of the secondary hub are perpendicular to each other, and the pair of the first openings of the secondary hub are perpendicular to the second opening of the secondary hub.

A fourth aspect of the invention relates to a method for connecting the block or the connection and support device or the assembly in the embodiments with an apparatus and a support, where the block or device having a main body including a plurality of mounting holes, the plurality of mounting holes including a first series of mounting holes and a second series of mounting holes, where each of the mounting holes from the second series of mounting holes is located proximal to a mounting hole from the first series of mounting holes and is arranged in a radial direction and closer to the center of main body with respect to the mounting hole from the first series of mounting holes, where the support includes a plurality of mounting holes corresponding to the first series of mounting holes and the second series of mounting holes, where the apparatus includes a plurality of mounting holes corresponding to either one of the first series of mounting holes or the second series of mounting holes, wherein method including the steps of a) connecting the block or device with the support, by a set of mounting members engaging with either the first series of mounting holes or the second series of mounting holes and the corresponding mounting holes on the support, such that the back surface of the main body is facing the support, b) connecting the block or device and the support to the apparatus, by another set of mounting members engaging with the other series of the first series of mounting holes and the second series of mounting holes, the corresponding mounting holes on the support, and the plurality of mounting holes on the apparatus, such that the front surface of the main body is facing the apparatus.

An aspect of the present invention is a connection and support device (which can also be regarded as a block) for use with a computer monitor (or other flat-screen display). The connection and support device supports the computer monitor and may also allow the connection of various accessories, for example, a light, a webcam, a microphone, etc. The device has a novel design that brings about modularity. It may allow non-proprietary threads, arms, tripod heads, etc. to be used, which provides significantly enhanced versatility and user experience. The device may be coupled with a monitor and a support by industrial installation standards, such as standards of VESA (the abbreviation of the Video Electronics Standards Association), so that it can be readily used for any existing standard monitors without the need of further modifications or additional equipment. VESA is an international technical standards organization for computer display standards and its official website is https://vesa.org/. The device may be coupled with a monitor and a support by VESA installation. Those couplings of displays using VESA standards may be called VESA installations. The VESA installation exists for coupling between the monitor and the support and may be used for the coupling of the connection and support device with the monitor and the support. Another advantage of this invention may be that multiple external devices can be mounted on a side of the device while reducing the chance that they will bump into each other, given the limited amount of space available.

### BRIEF DESCRIPTION OF THE DRAWINGS

FIG. 1 shows a perspective view of an embodiment of the connection and support device of the present invention;

FIG. 2 shows a front view of the device in FIG. 1, with an enlarged section view more clearly showing angles;

FIG. 3 shows a cross-sectional view of the device of FIG. 1, along line A-A′;

FIG. 4a shows an embodiment of an application case of the device in FIG. 1, in which an opening on the top side of the device is in use;

FIG. 4b shows another embodiment of an application case of the device in FIG. 1, in which an opening from the top side and two openings from the left (or right) side of the device are in use;

FIG. 4c shows a further embodiment of an application case of the device in FIG. 1, in which two openings from the top side of the device are in use;

FIG. 4d shows a further embodiment of an application case of the device in FIG. 1, in which three openings from the top side of the device are in use;

FIG. 4e shows a further embodiment of an application case of the device in FIG. 1, in which an opening from the top side, an opening from the left (or right) side, and an opening from the right (or left) side of the device are in use;

FIG. 4f shows a further embodiment of an application case of the device in FIG. 1, in which an opening on the bottom side of the device is in use;

FIG. 4g shows a further embodiment of an application case of the device in FIG. 1;

FIG. 5a shows a perspective view of an illustration of the embodiment shown in FIG. 4b, in which a web cam is mounted at the top side and a microphone is mounted at the left (or right) side via extension members;

FIG. 5b shows a front view of the illustration in FIG. 5a.

FIG. 6 is a schematic drawing showing an embodiment of the device coupled between an electronic device and a support.

### DESCRIPTION OF THE PREFERRED EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

It should be understood that relational terms, such as, but not limited to, “front”, “back”, “top,” “bottom” “left” “right”, etc. are used herein for the sake of clarity and/or for description of embodiments with figures, and are not intended to limit the scope of the invention.

The term “different” used to describe bore alignments in the embodiments of the present invention may mean the orientations of the bore alignments are not parallel to each other.

In some embodiments and in the present description of the invention, the connection and support device may be referred as a block, and vice versa. Mounting holes may be referred as mounting apertures, and vice versa. Bore alignment of an opening may be referred as axis of the opening, and vice versa. A mounting rod may be used as an example of an extension member.

An embodiment of the invention herein relates to a connection and support device containing a main body having a front surface of the main body. The main body contains a back surface of the main body, the back surface being opposite to and parallel to the front surface, and four sides. The four sides are a left side disposed between the front surface and the back surface, and where the left side is perpendicular to the front surface and the back surface, a top side disposed between the front surface and the back surface and where the top side is perpendicular to the front surface and the back surface, and where the top side is perpendicular to the left side, a right side disposed between the front surface and the back surface and perpendicular to the front surface and the back surface, and where the right side is perpendicular to the top side, a bottom side disposed between the front surface and the back surface and perpendicular to the front surface and the back surface, and where the bottom side is perpendicular to the right side. The main body contains a plurality of openings at a location selected from the group consisting of the left side, the top side, the right side, the bottom side, and a combination thereof, each of the plurality of openings is adapted to accommodate an extension member.

In an embodiment of the present invention, a connection and support device is provided. In particular, the connection and support device is provided for connection and support of one or more external devices to be added in close proximity to an apparatus (e.g. an electronic device), i.e. beside a side of the apparatus. The electronic device may be, for example, a monitor. For example, the monitor can be a flat panel monitor. In general, a monitor can be positioned at a working station, for instance, on a table. A support (e.g. in form of a stand) is provided to secure the monitor on the table. The connection and support device can be connected between the electronic device and the support. Without intending to be limited by theory, it is believed that upon connection, for instance, the front surface of the main body of the connection and support device is facing the electronic device and the back surface of the main body of the connection and support device is facing the support.

In an embodiment of the present invention, each opening has a bore alignment, and where the bore alignment of at least one of the plurality of openings is tilted with an angle compared with the bore alignment of at least one other opening. An opening may be in shape of a circular cylinder. The term bore alignment of an opening refers to a longitudinal axis which is parallel to the length direction of the opening. A variety of different orientations of the bore alignments and thus their respective openings may allow versatile setup of external devices on the connection and support device.

In an embodiment of the present invention, the location is the left side, the top side, and the right side, and each location includes a plurality of openings. Multiple openings on a side may allow the user to use one or more openings to set up one or more extension members on the same side. Without intending to be limited by theory, as extension members and external devices may not always be intended to be arranged in a vertical position at a side (e.g. the top side) of an apparatus (e.g. a monitor), it is believed that multiple openings on each side provide versatility in positioning of one or more external devices beside different sides of the apparatus.

In an embodiment of the present invention, the location further includes a recess, and the recess includes an opening. This may allow the opening located at the recess to be oriented in a different way compared with other openings, rendering more ways to install extension members and external devices on the device. The recess may also allow more space to accommodate an extension member, and optionally to accommodate a washer sleeved on an end of the extension member engaging with the opening. The washer may be squeezed between the extension member and the main body after the extension member is securely mounted on the main body, which may prevent rotational forces from un-fastening the extension member, especially when there are heavy external devices attached to it.

In an embodiment of the present invention, the recess includes a primary slanted portion. The primary slanted portion is arranged to be inclined from the side where the recess is located. The opening is provided on the primary slanted portion such that the bore alignment of the opening is tilted with an angle compared with the side where the recess is located. As such, the recess may provide a concave space for formation of an opening with a tilted angle and for installation of an external device, without the need of additional adjustment means to the connection and support device.

In an embodiment of the present invention, the recess also includes a secondary slanted portion. The angle between the primary slanted portion and the side where the recess is located is smaller than the angle between the secondary slanted portion and the side. A turning portion is provided at the bottom of the recess and connects the primary slanted portion and the secondary slanted portion. As both the primary slanted portion and the secondary slanted portion start at the same level from the side where the recess is located and end at substantially the same level at the bottom of the recess, given smaller angle of the primary slanted portion, the primary slanted portion has a relatively larger area than the secondary slanted portion. This design may provide a sufficient space for formation of an opening with a tilted angle inside the recess and for installation of an external device with a desired orientation.

In an embodiment of the present invention, the angle between the primary slanted portion and the side where the recess is located is from about 5° to about 60°, or from about 15° to about 35°, or from about 20° to about 30°, or about 21°, or about 22°, or about 23°, or about 24°, or about 25°, or about 26°, or about 27°, or about 28°, or about 29° or about 30°. As such, it is believed that a range of angles is defined for desired orientation of the bore alignments and thus the openings at recesses.

The one or more of the above embodiments may allow an extension member to be installed by engaging with an opening located at a recess. As such, the extension member may be arranged in a desirable orientation. In these embodiments, the bore alignment of the opening at a recess may be different to the bore alignments of other openings located at other recesses or not located at a recess. The user may choose which opening or which combination of openings they may use in a certain scenario of using the connection and support device. Another advantage brought about by the embodiments may be to reduce the chance the external devices and extension arms to bump into each other, when there are multiple external devices mounted on the device, especially when more than one external device mounted at the same side of the device, while being able to maintain a relatively compact design of the connection and support device. In addition, the embodiments may allow the external devices to be mounted and displayed on a side of an apparatus, with adjustable positions and inter-device distances, in cooperation with adjustable extension members.

In an embodiment of the present invention, the left side includes an opening, the right side includes an opening, and the bore alignments of the openings are collinear. As such, it may open up the possibility of collaboration between collinear openings in the role of connecting and supporting extension members and external devices.

In an embodiment of the present invention, the device includes from about three to about ten openings on a side. While this range of opening number may allow for multiple extension members and thus external devices to be attached on the device, it may be implemented at a certain portable size of the device.

In an embodiment of the present invention, the bore alignment of each of the openings is different. A variety of bore alignments may increase the utility of the connection and support device by allowing different ways to set up external devices.

In an embodiment of the present invention, the bore alignment is adjustable. This may allow the bore alignment to be adjusted with respect to the main body of the device. This feature may be implemented by providing an opening with a bore alignment, on a part of the main body, which the part may be configured to be moveable with respect to the main body to adjust the orientation of the bore alignment and to be secured when a target orientation of the bore alignment is achieved. The part of the main body may be in form of a movable block. There is provided securing means to secure the movable block with respect to the main body and to release the moveable block to allow it to move with respect to the main body. A joint part may be provided connecting the movable block and the main body, to guide the rotation of the movable block in a certain manner, for example, on a plane. The beneficial effect brought about by this adjustable feature may be further synergized by addition of adjustable extension members. For instance, these adjustable extension members may have ball joints.

In an embodiment of the present invention, the device includes about three openings on each of the four sides, and the bore alignment of each of the three openings on each of the four sides is different. This may allow the user to flexibly choose which bore alignment to be used to affix extension members depending on the user's needs. A variety of bore alignments may allow an angled or spaced-out arrangement of extension members on the device. For example, a webcam as an external device may be mounted on a middle opening of the three openings, and a lighting device as another external device may be mounted at either side of the webcam at an angle on one of the two other openings.

In an embodiment of the present invention, each of the left side and the right side includes two or three openings, where the bore alignments of the two or three openings are parallel to one another. As such, it may open up the possibility of collaboration between the parallel openings in the role of connecting and supporting extension members and external devices. A multiple number of openings may allow an increased number of extension members to each side. For instance, two openings at a side may be used to secure two extension members which may be arranged to be parallel to each other, thus equally spaced to each other in their length directions, hence the extension members collaboratively form a stronger carrying capacity with less potential to become loose when subject to external (rotational) forces. This may allow for placement of external devices at a greater distance from and/or with an angle to the main body of the connection and support device without unscrewing or bending.

In an embodiment of the present invention, the location includes two recesses. This may allow for angled arrangement of extension members without interfering with each other or with the connection and support device

In an embodiment of the present invention, the location is the top side.

In an embodiment of the present invention, one of the two recesses is located proximal to the left side and distant from the right side and the other of the two recesses is located proximal to the right side and distant from the left side. This defines a preferable positioning of the recesses in a scenario of two recess at the same side of the connection and support device.

In an embodiment of the present invention, the location is a side that includes three openings, where one of the three openings is the middle opening located between the other two openings and oriented perpendicular to the side where it is located, and where the other two openings are oriented away from the middle opening as observed externally to the device. As extension members and external devices may not always be intended to be located at the middle part of a side of an apparatus, e.g. a monitor, such arrangement of multiple openings may provide versatility in the positioning of extension members and thus external devices to each side of the main body, especially if the user wants a setup with multiple extension members at a single side, without interfering with the perpendicular positioning of an extension member, thus its external device, that is located at the middle opening at the same side of the main body.

In an embodiment of the present invention, the device includes a plurality of mounting holes for connecting the device with an apparatus and a support. The arrangement of openings and mounting holes (to be discussed later) on the connection and support device may allow the device to couple with extension members and external devices after coupling with the apparatus and/or the support, while minimizing torque effects.

In an embodiment of the present invention, where the location is the top side and the bottom side, each of which includes two recesses, where two recesses of the four recesses, one located at the top side and the other located at the bottom side, are proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side. The plurality of mounting hole are provided at the corner portions. Such design may be a preferable positioning arrangement of the recesses and mounting holes at the main body considering the compact structure of the device.

In an embodiment of the present invention, the plurality of mounting holes include four 100 mm×100 mm spaced mounting holes and four 75 mm×75 mm spaced mounting holes. Each of the 75 mm×75 mm spaced mounting holes is located proximal to a mounting hole from the 100 mm×100 mm spaced mounting holes and is arranged in a radial direction closer to the center of the main body with respect to the 100 mm×100 mm spaced mounting hole. As such, multiple sets (e.g. two sets) of mounting holes as provided may allow more versatile installation of the connection and support device on the apparatus and the support.

In an embodiment of the present invention, the location is the top side and the bottom side, each of which includes two recesses. The two recesses of the four recesses, one located at the top side and the other located at the bottom side, are located proximal to the left side and distant from the right side, and the other two recesses, one located at the top side and the other located at the bottom side, are located proximal to the right side and distant from the left side. Four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side. The plurality of mounting holes is typically provided at the corner portions. The main body is substantially in form of a ring structure with the one or more corner portions attached to its outer side. In an embodiment herein, the 100 mm×100 mm spaced mounting holes are located at the corner portions and the 75 mm×75 mm spaced mounting holes are located at the ring structure. This design may allow for optimized weight saving as the 100 mm×100 mm spacing of the first series (i.e. outer) mounting holes represents a reference to set dimensional limits for a connection and support device with minimum dimensions yet to be functional.

In an embodiment of the present invention, the connection and support device includes a central cavity in the middle of the main body. As such, the front surface and the back surface are communicated through the cavity portion, and the openings are exposed in the cavity. Optionally, the central cavity is in form of a cylinder with circular bases formed on the front surface and the back surface. Besides, the presence of the cavity may be beneficial for reduction of material costs and bringing about lighter weight to the connection and support device without compromising the strength of the connection and support device. The cavity may also facilitate the user to install and adjust mounting members and external devices in some scenarios.

In some embodiments of the present invention, the main body may be substantially in form of a rectangular prism. The four sides are provided at the main body substantially perpendicular to the front surface and the back surface. Optionally, the main body may be substantially in form of a square prism with a length of from about 105 mm to about 150 mm, or from about 110 mm to about 120 mm, or about 110 mm, or about 115 mm, or about 120 mm, and a thickness of from about 7 mm to about 40 mm, or from about 10 mm to about 30 mm, or from about 15 mm to about 25 mm, or about 15 mm, or about 20 mm, or about 25 mm. The central cavity may be in form of a cylinder with circular bases formed on the front surface and the back surface, where the diameters of the circular bases are from about 60 mm to about 90 mm, or from about 80 mm to about 86 mm, or about 80 mm, or about 81 mm, or about 82 mm, or about 83 mm, or about 84 mm, or about 85 mm, or about 86 mm. In the cases that the cavity and/or one or more recesses are present in these embodiments, they may be regarded as cutaway portions from the main body.

Without intending to be limited by theory, it is believed that the one or more of the above embodiments further define a few desirable features on the design of the block or the connection and support device. For instance, the positioning, orientation, sizing of the openings, the cavity, the recesses, mounting holes and the main body together or each may contribute to a connection and support device with a streamlined profile and compact structure, while being able to couple with a plurality of extension members and external devices, with a considerable strength and minimized torque effects. The connection and support device may be fabricated with suitable manufacturing techniques known in the art, such as computer numerical control (CNC) techniques with suitable materials, for example, aluminum-containing materials. Those skilled in the art may appreciate the use of other suitable materials known in the art in making connection and support equipment to make the connection and support device in the embodiments of the present invention.

In an embodiment of the present invention, a connection and support device, including a main body having a front surface of the main body. The main body contains a back surface of the main body, the back surface being opposite to and parallel to the front surface, and four sides. The four sides are a left side disposed between the front surface and the back surface, and where the left side is perpendicular to the front surface and the back surface, a top side disposed between the front surface and the back surface and where the top side is perpendicular to the front surface and the back surface, and where the top side is perpendicular to the left side, a right side disposed between the front surface and the back surface and where the right side is perpendicular to the front surface and the back surface, and where the right side is perpendicular to the top side, a bottom side disposed between the front surface and the back surface and where the bottom side is perpendicular to the front surface and the back surface, and where the bottom side is perpendicular to the right side. The main body contains a plurality of openings at a location selected from the group consisting of the left side, the top side, the right side, the bottom side, and a combination thereof. Each of the plurality of openings is adapted to accommodate an extension member. Each opening has a bore alignment, and at least one of the plurality of openings is tilted at a different angle compared with at least one other opening. The bore alignment of each of the openings is different. The bore alignment is adjustable. The location is the left side, the top side, and the right side, and each location includes a plurality of openings. The location further includes a recess, and the recess includes an opening. The left side includes an opening, the right side includes an opening, and the bore alignments of the openings are collinear. The main body is in form of rectangular shape. The four side surfaces are provided at the main body substantially perpendicular to the front surface and back surface. The device includes a central cavity in the middle of the main body so that the front surface and the back surface are communicated through the cavity portion, and the openings are exposed in the cavity. The device includes from about three to about ten openings on a side. In particular the device includes about three openings on each of the four sides, and the bore alignment of each of the three openings on each of the four sides is different. The middle opening of the three openings is oriented in a way perpendicular to the surface where it is located. The left and right openings of the three openings are oriented away from the middle opening as observed externally to the device.

Without intending to be limited by theory, it is believed that the device according to the embodiments of the present invention has a novel design that brings about modularity. It may allow non-proprietary threads, arms, tripod heads, etc. to be used, which provides significantly enhanced versatility and user experience. The device may be coupled with a monitor and a support by industrial installation standards, such as VESA standards, so that it may be readily used for any existing standard monitors without the need of further modifications or additional equipment. Another advantage of this invention may be that multiple external devices can be mounted on a side of the device while reducing the chance that they will bump into each other, given the limited amount of space available.

Another embodiment of the present invention relates to a method for connecting the block or the connection and support device with an apparatus and a support. The block or device has a main body including a plurality of mounting holes, which include a first series of mounting holes and a second series of mounting holes. Each of the mounting holes from the second series of mounting holes is located proximal to a mounting hole from the first series of mounting holes. Each of the mounting holes from the second series of mounting holes is arranged in a radial direction and closer to the center of main body with respect to the mounting hole from the first series of mounting holes. The support includes a plurality of mounting holes corresponding to the first series of mounting holes and the second series of mounting holes.

The apparatus includes a plurality of mounting holes corresponding to either one of the first series of mounting holes or the second series of mounting holes. The method includes the steps of connecting the device (or the block) with the support, by a set of mounting members engaging with either the first series of mounting holes or the second series of mounting holes and the corresponding mounting holes on the support, such that the back surface of the main body is facing the support. The device (or the block) and the support are connected to the apparatus by another set of mounting members engaging with the other series of the first series of mounting holes and the second series of mounting holes, the corresponding mounting holes on the support, and the plurality of mounting holes on the apparatus, such that the front surface of the main body is facing the apparatus. As such, multiple sets (e.g. two sets) of mounting holes provided on the main body of the device, as well as on the support, may offer an additional way to install the device between the apparatus and the support. In particular, the block or device may be installed on a support first and then the apparatus is installed to the device and the support. This may allow the user to install extension members and external devices on the connection and support device after the device is installed on the support, before the apparatus is added to the device and the support. As the apparatus, e.g. a monitor, is usually more bulky compared with the device and the support. This method may allow more space to install and adjust the extension members and external devices.

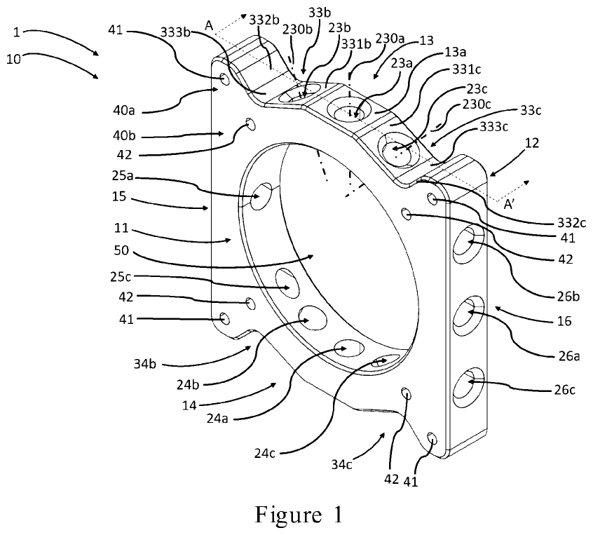

Referring to FIGS. 1-3, 4g and 6, in some embodiments, a block 1 is provided for mounting accessories to a computer monitor which includes a mounting interface 80a with screw couplings including mounting holes 801. The block 1 includes a block with substantially parallel opposing surfaces 11,12 and a periphery of the block extending between the two surfaces 11,12. One of the surfaces 11,12 is adapted to abut the mounting interface 80a. The opposing surfaces 11,12 are spaced apart in a through-thickness direction by a dimension defining a thickness of the block. The block 1 includes four first mounting apertures 41 and four second mounting apertures 42, both extending in the through-thickness direction between the two surfaces 11,12. The four first mounting apertures 41 are disposed in a first square array having a centre. The four second mounting apertures 42 are disposed in a second square which is smaller than the first square and equidistant from the centre and angularly aligned with the four first mounting apertures 41. The mounting holes 801 of the monitor are disposed in two square arrays respectively corresponding to the first square array and the second square array of the mounting apertures 41,42 of the block 1.

The block 1 includes a plurality of like openings in the periphery that are configured to receive mounting rods. each opening has an axis disposed in an imaginary plane parallel to the two surfaces 11,12. The openings include a first pair of parallel openings (e.g. openings 25b, 25c) for extending substantially horizontally in use. The openings of the first pair disposed are adjacent one another on a first portion of the periphery. The openings include a second pair of parallel openings (e.g. openings 26b, 26c) for extending substantially horizontally in use. The openings of the second pair are disposed adjacent one another on a second portion of the periphery substantially opposite the first portion of the periphery. The openings further include an orthogonal opening (e.g. opening 23a) aligned substantially orthogonally to the first and second pairs of openings for extending substantially upwards from the block in use. The orthogonal opening is disposed in an intermediate portion of the periphery between the first and second portions, and is disposed uppermost in use. Each of the openings contains an internal screw thread for a threaded connection with a mounting rod. As an exemplary illustration, an internal screw thread 231a at the inner wall of the opening 23a is labelled in FIG. 3. A variety of different orientations of multiple openings may allow versatile setup of external accessories on the block. It may also open up the possibility of collaboration between parallel openings in the role of connecting and supporting accessories.

The block 1 includes a central through-extending cavity 50 that extends between the two surfaces 11,12 such that the block has ring-like form. The cavity 50 is circular in cross-section and its axis passes through the centre of the square arrays of the mounting apertures 41,42. The openings further includes a pair of acutely inclined openings (e.g. openings 23b and 23c) in the intermediate portion of the periphery. The acutely inclined openings are inclined acutely to the orthogonal opening and disposed on opposite sides of the orthogonal opening. The periphery includes respective circumferential faces surrounding the circumferences of the orthogonal opening and each of the acutely inclined openings. Each of the circumferential faces is aligned substantially perpendicular to respective axes of the openings. The intermediate portion of the periphery further includes a respective concavity at least partially bounded by the respective circumferential faces around each of the acutely inclined openings.

Referring to FIG. 1 an embodiment of the connection and support device 1 of the present invention has a main body 10 including: a front surface 11 of the main body 10, a back surface 12 of the main body 10, and four sides. The back surface 12 is opposite to and parallel to the front surface 11. The four sides include a top side 13, a bottom side, 14, a left side 15 and a right side 16. The top side 13 is disposed between the front surface 11 and the back surface 12, and the top side 13 is perpendicular to the front surface 11 and the back surface 12. The bottom side 14 is disposed between the front surface 11 and the back surface 12, and the bottom side 14 is perpendicular to the front surface 11 and the back surface 12. The left side 15 is disposed between the front surface 11 and the back surface 12 and perpendicular to the front surface 11 and the back surface 12, and where the left side 15 is perpendicular to the top side 13. The right side 16 is disposed between the front surface 11 and the back surface 12 and perpendicular to the front surface 11 and the back surface 12, and where the right side 16 is perpendicular to the top side 13 and the bottom side 14. The main body contains a plurality of openings 23a, 23b, 23c, 24a, 24b, 24c, 25a, 25b, 25c, 26a, 26b, 26c at the top side 13, the bottom side 14, the left side 15, and the right side 16. Each of the plurality of openings is adapted to accommodate an extension member.

There are provided two recesses 33b, 33c on the top side 13 of the main body 10 of the device 1. Both of the recesses 33b, 33c are not positioned at the center of the top side 13. When viewed from the front, one 33b of the recesses is located proximal to the left side 15, while the other recess 33c is located proximal to the right side 16, such that a surface portion 13a is provided at the central part of the top side 13, between the two recesses 33b, 33c. There is provided an opening 23a on the surface portion 13a. The opening 23a has a bore alignment 230a perpendicular to the surface portion 13a, and thus to the top side 13. The opening 23a is provided with internal threads 231a at its inner wall. There is provided a primary slanted portion 331b at the left recess 33b on the top side 13. The primary slanted portion 331b may be arranged to be inclined from the top side 13 (or the surface portion 13a of the top side 13). There is provided a secondary slanted portion 332b at the same recess 33b next to the primary slanted portion 331b. A rounded-shape turning portion 333b is provided at the bottom of the recess 33b, which connects with the primary slanted portion 331b and the secondary slanted portion 332b. The turning portion 333b may bring about a smooth connection to the two portions 331, 332b, rendering a streamlined profile to the device 1. There is also provided a primary slanted portion 331c at the right recess 33c on the top side 13, along with a secondary slanted portion 332c and a turning portion 333c, which are similar yet symmetrical to their counterparts at the recess 33b about the bore alignment 230a.

In this example, the two primary slanted portions 331b, 331c each have an opening. They have the same slope (in term of magnitude) with respect to the surface portion 13a, but facing obliquely opposite each other. The bore alignment 230b of the left opening 23b is oriented away from the bore alignment 230a of the middle opening 23a. The bore alignment 230c of the right opening 23c is oriented away from the bore alignment 230a of the middle opening 23a. The bore alignments 230a, 230b, 230c are divergent to each other as observed externally to the device. In other terms, the two primary slanted portions 331b, 331c are symmetrical to each other about the bore alignment 230a. As such, the design may allow multiple external devices to be mounted on a side (e.g. the top side 13) of the device 1 while reducing the chance for these external devices to bump into each other, given the limited amount of space available on the compact structure of the device 1.

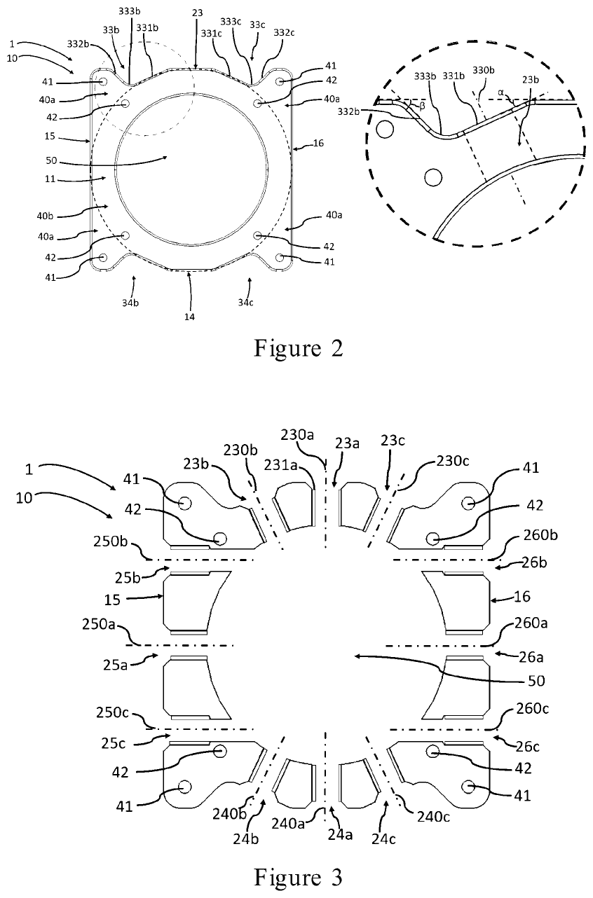

With reference to FIG. 2, the angle α between the primary slanted portion 331b and the top side 13 is smaller than the angle β between the secondary slanted portion 332b and the top side 13. The angle α may be from about 5° to about 60°, from about 15° to about 35°, from about 20° to about 30°, about 21°, about 22°, about 23°, about 24°, about 25°, about 26°, about 27°, about 28°, about 29° or about 30°. Each of the openings 23a, 23b, 23c has a bore alignment, i.e. the bore alignments 230a, 230b, 230c as shown in FIG. 1. The openings 23a, 23b, 23c are oriented to a different direction compared with one another. In particular, the opening 23a is oriented perpendicular to the top side 13, the opening 23b is tilted with an angle α and the opening 23c is tilted with the same angle as angle α but in an opposite direction, with respect to the top side 13 or the surface portion 13a. The openings 23a, 23b, 23c may be internally threaded for coupling with an extension member.

There are provided openings 24a, 24b, 24c at the bottom side 14 of the main body 10, with the opening 24b located at a recess 34b and the opening 24c located at a recess 34c, which are identical but inverted compared with the configuration of the openings 23a, 23b, 23c and recesses 33b, 33c at the top side 13. In other terms, the configuration of the openings 24a, 24b, 24c and recesses 34b, 34c on the bottom side 14 is symmetrical to that of the top side 13 in this example. Optionally, at least one bore alignment of the openings 23a, 23b, 23c on the top side 13 is collinear with one of the openings 24a, 24b, 24c on the bottom side 14. In this example, there are three pairs of collinear bore alignments and thus openings between the top side 13 and the bottom side 14, namely, opening 23b with opening 24c, opening 23a with opening 24a, opening 23c with opening 24b.

There are also provided openings 25a, 25b, 25c on the left side 15 and openings 26a, 26b, 26c on the right side 16. At least one bore alignment of the openings 25a, 25b, 25c on the left side 15 is collinear with one of the openings 26a, 26b, 26c on the right side. In this example, as shown in FIG. 3, the bore alignments of the openings 25a, 25b, 25c at the left side 15 are perpendicular to the left side 15. The bore alignments of the openings 26a, 26b, 26c at the right side 16 are perpendicular to the right side 16. There are three pairs of collinear bore alignments and thus openings between the left side 15 and the right side 16, namely, opening 25a with opening 26a; opening 25b with opening 26b; opening 25c with opening 26c. The openings at the left side 15 and right side 16 are internally threaded. The distance between opening 25b and opening 25c may be about 60 mm (measured from the centers of the openings), which matches certain camera rig alignments with a pair of parallel rods in a possible application scenario.

As such, the collinear bore alignments between the top side 13 and the bottom side 14 intersect with each other, while the collinear bore alignments between the left side 15 and the right side 16 are parallel to each other. At least some of the openings are internally threaded. For example, the threads are of M12 size. The collinear bore alignments may allow some types of special extension members with two sections of threads to be installed and fixed by engaging with the collinear pairs of the openings. As such, the distance of the threads equals the distance between a pair of opposing and collinear openings, for example, openings 25a and 26a or other collinear openings pairs. The length of the threads along the length direction of the extension member may be equal to that of the threads within the openings.

In some embodiments of the present invention, the lengths of the openings along their respective bore alignment directions are the same as their respective internal threads. In some other embodiments, the lengths of the openings are longer than their respective internal threads. With reference to the example shown in FIG. 3, the openings each include a frustum portion located at an end of each opening away from the center of the main body 10. In other terms, the frustum portion of an opening adjoins the side when the opening is located. For instance, each frustum portion of the openings at the top side 13 and the bottom side 14 adjoins either a respective primary slanted portion at a recess or a surface portion of the side where the opening is located. Each frustum portion at the left side 15 adjoins the outer surface of the left side 15, and each frustum portion at the right side 16 adjoins the outer surface of the right side 16. Each of the frustum portions' diameters gradually increases from its closer base to its remote base with respect to its opening. At least some of the openings have a nested structure. In this example, openings 25b and 25c at the left side 15 and openings 26b and 26c at the right side 16 have a nested structure. In particular, the nested openings each have two sections, namely an outer section and an inner section. The inner section has a smaller diameter and is closer to the center of the main body 10 and the outer section has a larger diameter and further away from the center of the main body 10. As such, these nested openings each in a direction towards the center of the main body 10 have a frustum portion, an outer section and an inner section in order. The frustum portion may allow the user to conveniently insert extension members into the target openings. In the case that a washer is added on an extension member, the washer would typically be placed between and pressed by the extension member and the frustum portion, thus enhancing fastening of the extension member of the connection and support device. The nested structure of the opening may serve to control the engagement of an extension member with an opening. In particular, internal threads are only provided at the outer section of an opening, while the inner section of the opening may serve to limit the progression of an extension member with a diameter larger than that of the inner section and may allow an extension member with a diameter smaller or equal to that of the inner section to pass through.

Returning to FIGS. 1 and 2, the main body 10 of the device 1 includes a plurality of mounting holes 41, 42 for connecting the device 1 with an apparatus and a support. For instance, the apparatus may be an electronic device such as a monitor. The support may be a stand for supporting the apparatus. The main body 10 may be regarded as substantially in form of a ring structure 40b with the one or more corner portions 40a attached to its outer side. A corner portion 40a is formed between a recess and an adjacent side that is closer to the recess and adjacent to the side where the recess is located. In this example, there are four corner portions 40a respectively formed between recess 33b and side 15, between recess 33c and side 16, between recess 34c and side 16, and between recess 34b and side 15. The plurality of mounting holes include a first series of mounting holes 41 and a second series of mounting holes 42. The first series of mounting holes 41 are located at the corner portion 40a and the second series of mounting holes 42 are located at the ring structure 40b. Each of the mounting holes from the second series of mounting holes 42 is located proximal to a mounting hole from the first series of mounting holes 41 and is arranged in a radial direction and closer to the center of main body 10 with respect to the mounting hole from the first series of mounting holes 41. The first series of mounting holes 41 have a larger inter-hole spacing on average than the second series of mounting holes 42. In this example, the first series of mounting holes 41 are 100 mm×100 mm spaced mounting holes, and the second series of mounting holes 42 are 75 mm×75 mm spaced mounting holes. Coexistence of multiple mounting positions may allow the device 1 to be used on apparatuses of different sizes. The mounting holes may be internally threaded for coupling of the device 1 with an apparatus and a support via screws.

The first series of mounting holes 41 are arranged to be in a rotationally symmetrical shape, such as a square. The second series of mounting holes 42 are also arranged to be a rotationally symmetrical shape. In particular, the first series of mounting holes 41 and the second series of mounting holes 42 have the same 4-fold rotational symmetries of 0°, 90°, 180° and 270° about an axis which passes through the centers of both the front surface 11 and the back surface 12. As such, the design may allow the main body 10, thus the four sides and the bore alignments, to be mounted in multiple orientations. For instance, by rotating the main body 10 of the device 1 by 90° clockwise before it is secured on the apparatus or the support, the top side may now face the right side (when viewed from the front). The other three sides are also turned by 90° clockwise accordingly to reach their own new positions and orientations, and thus their bore alignments. This may allow versatile extension members attached to the main body 10, to be oriented in many directions, which may provide further synergy in combination with different bore alignments on a single side of the main body 10. There is provided a cavity 50 located at the central part of the main body 10 of the device 1 such that the front surface 11 and the back surface 12 communicate with each other through the cavity 50. One or more openings from one or more sides of the four sides 13,14,15,16 are exposed in the cavity 50. In the example, the cavity 50 is in form of a cylinder with circular bases formed on the front surface 11 and the back surface 12. The presence of the cavity 50 may be beneficial for reduction of material costs and bringing about lighter weight to the device 1 without compromising its strength for support and connection. The cavity 50 may also facilitate the user to install and adjust mounting arms and external devices in some scenarios. Although not shown in the figures, frustum portions may be provided on one or more mounting holes, in a similar manner of the frustum portions on the openings. Frustum portions may be provided on the openings the front surface 11 and/or the back surface 12. In an embodiment of the present invention, frustum portions may be provided on the front surface 11 that faces the apparatus upon coupling with the apparatus. Frustum portions on the mounting portions serve a slightly different purpose compared with those on the openings, as they help to accommodate heads of mounting members e.g. screws upon mounting with an apparatus and/or a support. According to an embodiment of the present invention, a method for connecting a connection and support device with an apparatus and a support includes the step of connect the device with the support first via a set of mounting members. With the frustum portions provided on the mounting holes at a surface of the device (e.g. the front surface 11), the heads of the mounting members can be at least be flush with the front face 11 or be within the respective frustum portions after the device is mounted on the support, so that the mounting members would not hinder the contact and installation between the device and the apparatus in a later step of coupling the device and the support with the apparatus.

The example shown in the FIGS. 1-3 illustrates an embodiment of connection and support device 1 of the present invention, in which on the left side 15 and the right side 16, there are provided the openings with bore alignments perpendicular to respective sides where the openings are located, and on the top side 13 and the bottom side 14, there are provided recesses and the openings with inclined bore alignments. There are other embodiments of the present invention that possess different configurations on the four sides. For instance, although not shown in the figures, in some embodiments of the present invention, the connection and support device may have one or more recesses on one of the four sides, while the other three sides have no recesses, i.e. all openings on the three sides are perpendicular to the sides where they are located. In particular, the only side with recesses may have the same configuration of recesses and openings as that on the top side 13 or bottom side 14 of the example in FIGS. 1-3, and the other three sides may have the same configuration of openings as that on the left side 15 or right side 16 of the example in FIGS. 1-3 .

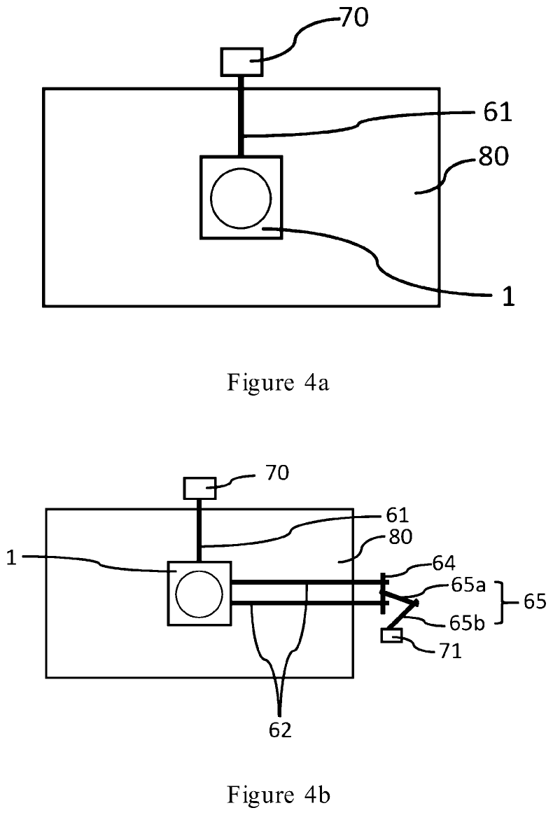

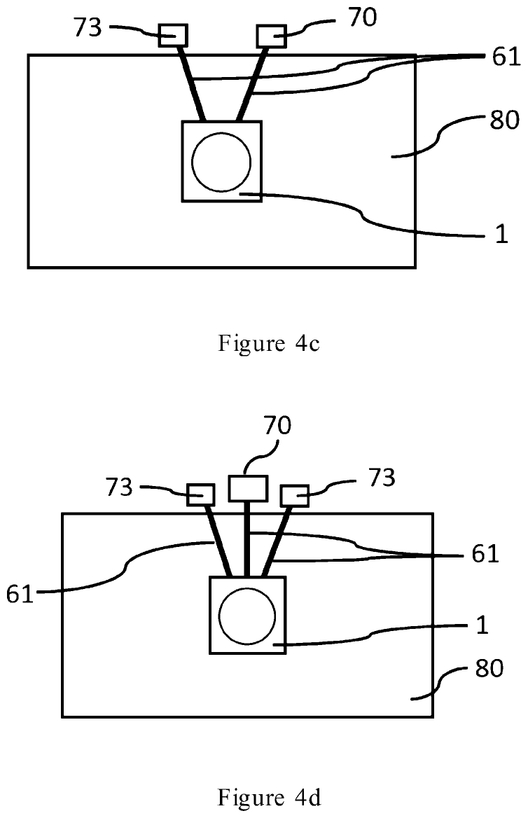

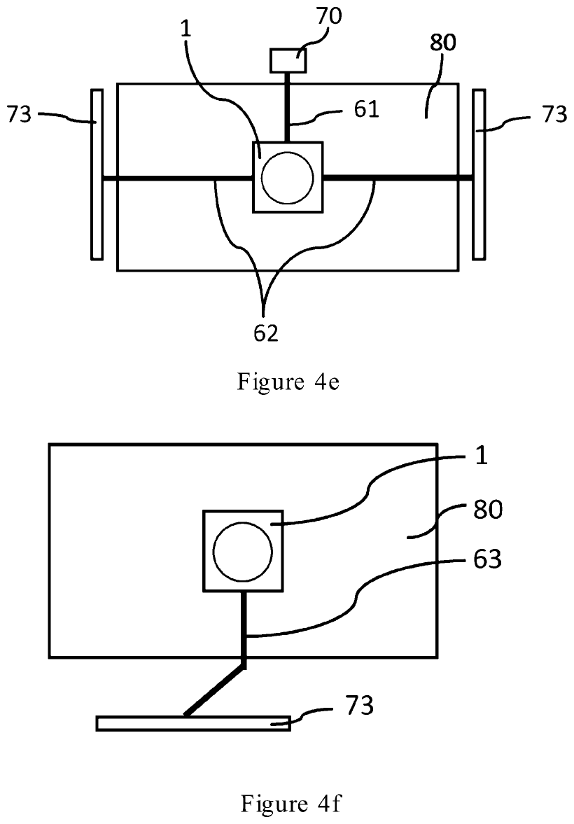

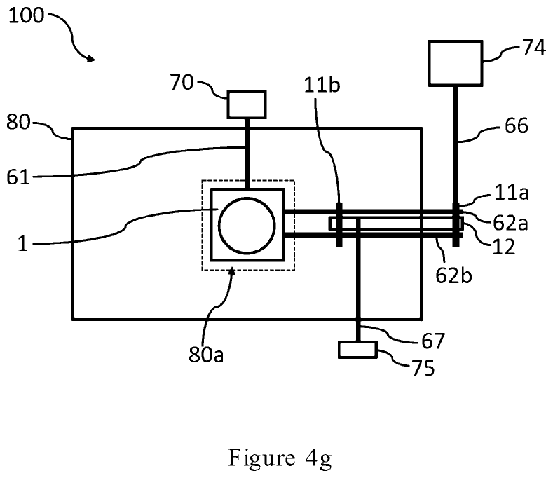

FIG. 4a shows an embodiment of an application case of the device in FIG. 1. The device 1 is installed at the back side of an electronic device 80 such as a monitor. An external device 70 (e.g. a webcam) is coupled to the device 1 via an extension member 61. The device 1 used in this example may be the device 1 in the embodiment in FIGS. 1, 2, 3, or some other embodiments of the present invention. Through engagement with an opening on the top side of the device 1, the extension member 61 is arranged and secured in a vertical manner. The webcam is secured and positioned on the top of the monitor 80. It is believed that the user, i.e. the viewer could see the webcam located adjacent to the top side of the monitor 80 from the front of the monitor 80.

FIG. 4b shows another embodiment of an application case of the device in FIG. 1. An external device 70 is installed at the device 1 in a similar manner as the embodiment in FIG. 4a. In addition, another external device 71, which may be a microphone, is coupled with the device 1 via a pair of extension members 62 at the right side (when viewed from the back). The pair of extension members 62 may be different with the extension member 61 by at least length. The one of the two extension members 62 is connected with an opening of the device 1 at an end and the other of the two extension members 62 is connected with another opening at an end. The two openings of the device 1 that are connected with the extension members 62a, 62b are located on the same side of the device 1 and the bore alignments of the two openings are parallel to each other. The two extension members connected to their respective openings are thus parallel to each other. Both of the two extension members 62 are connected to a vertical rod 64 at their other ends. A further extension member 65, which includes two rods 65a, 65b, is rotatably coupled at the middle part of the vertical rod 64 with one end of the rod 65a. The other end of the rod 65a is rotatably connected with one end of the rod 65b. The other end of rod 65b is connected with a holder holding the external device 71.

FIG. 4c shows a further embodiment of an application case of the device in FIG. 1. An external device 70 (e.g. a webcam) is coupled to the device 1 via an extension member 61. Through engagement with an opening on the top side of the device 1, the extension member is arranged and secured in an oblique manner. Another external device 73 (e.g. a lighting device) is coupled to the device 1 via another extension member 61, which is engaged with another opening of the top side so that the extension member is also arranged and secured in an oblique manner, but in an opposite direction compared with the previous extension member 61.

FIG. 4d shows a further embodiment of an application case of the device in FIG. 1, in which an external device 70 (e.g. a webcam) is coupled to the device 1 in a similar manner as the external device in FIGS. 4a and 4b. Two external devices 73 (e.g. two lighting devices) are coupled with the device 1 in a similar manner respectively as the two external devices in FIG. 4c.

FIG. 4e shows a further embodiment of an application case of the device in FIG. 1. An external device 70 (e.g. a webcam) is coupled to the device 1 via an extension member 61 in a similar manner as the external device in FIGS. 4a and 4b. One external device 73 is coupled at the left side (viewed from the back) of the device 1 via an extension member 62 and another external device 73 is coupled at the right side of the device 1 via another extension member 62. As shown in the figure, the external devices 73 may be lighting devices and are in a bar shape and placed vertically adjacent to the left and right sides of the monitor 80.

FIG. 4f shows a further embodiment of an application case of the device in FIG. 1, in which an external device 73 (i.e. a keyboard tray) is coupled to the device 1 via an extension member 63 that is adjustable and extensible. As such, the keyboard tray is configured to be movable between a lower use position and a higher suspended position.

In an embodiment of the present invention, as shown by FIG. 4g, an assembly 100 including the device 1 is provided. The device 1 is installed with a mounting interface 80a at the back side of an electronic device 80 (e.g. a monitor) with one of its two opposing surfaces abutting the mounting interface 80a of the electronic device 80. An external device 70 is coupled to the device 1 via an extension member 61. The device 1 used in this example may be the device 1 in the embodiment in FIGS. 1, 2 and 3, or in some other embodiments of the present invention. Through engagement with an opening on the top side of the device 1, the extension member 61 is arranged and secured in a vertical manner above the device 1. The external device 70 is thus secured and positioned on the top of the electronic device 80. It is believed that with this configuration, the external device 70, which may be a webcam, a lighting device, a microphone, etc., is located in a desirable position for performing its function above a station (e.g. a desk) on which the electronic device 80 is located.

A pair of extension members 62a, 62b are provided and connected to respective openings in parallel on the right side of the device 1 (when viewed from the back side of the electronic device 80). The pair of extension members 62a, 62b may be different with the extension member 61 by at least their lengths. For instance, the lengths of extension members 62a, 62b are equal to each other and are longer than that of the extension member 61. The extension member 62a is connected with an opening of the device 1 at an end and the extension member 62b is connected with another opening of the device 1 at an end. The two openings of the device 1 that are connected with the extension members 62a, 62b are located on the same side of the device 1 and their bore alignments are parallel to each other. The two extension members 62a, 62b are thus arranged to be parallel to each other.

The assembly 100 further includes a secondary hub 11a, which may be in form of a rod clamp. The secondary hub 11a is coupled with the other ends of the extension members 62a, 62b. The secondary hub 11a is configured to accommodate and fix an extension member 66 arranged in a direction different from the extension members 62a, 62b. In this example, the extension member 66 is arranged to be perpendicular to the extension members 62a, 62b and above the secondary hub 11a, with an end coupled with the secondary hub 11a. An external device 65 is coupled with the other end of the extension member 66. In this way, the external device 65 is coupled with the secondary hub 11a, and thus coupled with the device 1 by extension members. The device 1 may be regarded as a primary hub for coupling with external devices. The secondary hub 11a, which is supported by the device 1, can be used for coupling additional external devices. The collaboration of the primary hub (i.e. device 1) and the secondary hub 11a allows more versatile configurations with various external devices and extension members.

A secondary hub 11b may be configured to be connectable with the device 1 via extension members at not only an end of an extension member, but at any position along the length of the extension member. In this example, the assembly 100 further includes a secondary hub 11b, which may be in form of rod clamp. The secondary hub 11b is coupled with the extension members 62a, 62b at an intermediate position at the length of the extension members 62a, 62b. A third hub 12, which is in form of plate including multiple openings, is provided between the two secondary hubs 11a, 11b. The third hub 12 is coupled to the two secondary hubs 11a, 11b at its two opposing ends. An external device 75 is coupled to the third hub 12 via an extension member 67. In this way, the external device 75 is supported by the device 1.

The secondary hub 11a, 11b includes a pair of parallel openings and a second opening (not shown). Each of the pair of the parallel openings has an axis aligned with respective one of the parallel openings on the right side of the device 1 and receives respective one of the extension members 62a, 62b. The second opening receives one end of the extension member 66 with another end coupled with the external device 74.

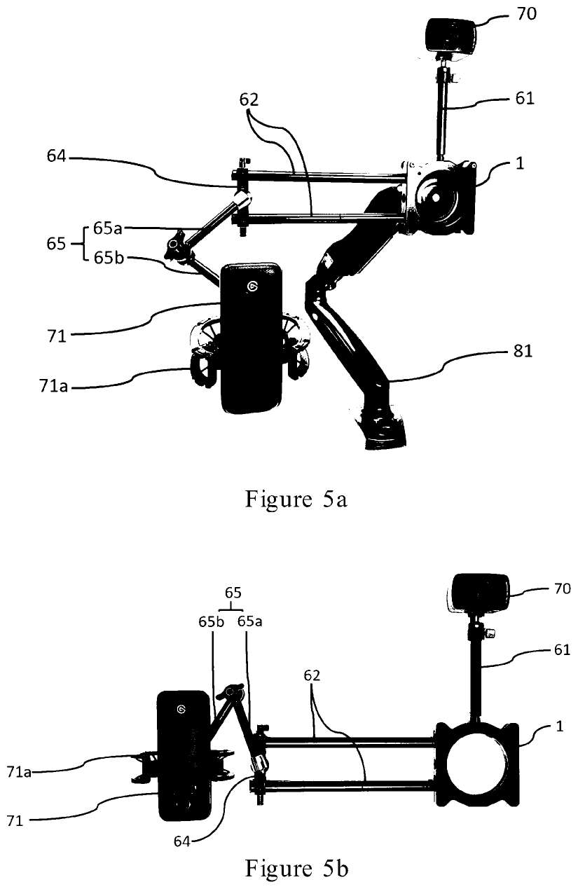

FIG. 5a shows a perspective view of an illustration of the embodiment shown in FIG. 4b. FIG. 5b shows a front view of the illustration in FIG. 5a. For the sake of clarity, both figures dispense with the electronic device (e.g. a monitor). A support 81 in form of a stand is shown in FIG. 5a, but is dispensed with in FIG. 5b to more clearly show the connection of the devices and extension members. An external device 70, i.e. a web cam is mounted at the top side via an extension member 61. In particular, the web cam is coupled with the middle opening at the top side of the device 1 by an extension member 61 i.e. a single rod extension arm with a tripod head. A microphone 71 is mounted at the left side (when viewed from the front) via a pair of parallel extension members 62. In particular, one of the two extension members 62 is connected with an opening at an end at the left side of the device 1 and the other of the two extension members 62 is connected with another opening at the same side at an end. Both of the two extension members 62 are connected to a vertical rod 64 at their other ends. A further extension member 65, which includes two rods 65a, 65b, is rotatably coupled at the middle part of the vertical rod 64 with one end of the rod 65a. The other end of the rod 65a is rotatably connected with one end of the rod 65b. The other end of rod 65b is connected with a holder 71a holding an external device 71, i.e. a microphone.

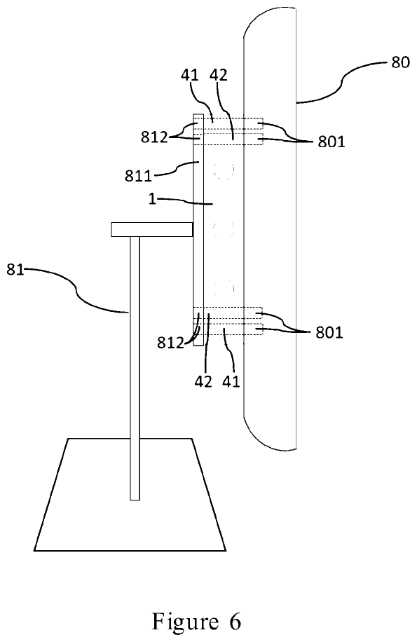

FIG. 6 is a schematic drawing showing an embodiment of the device 1 coupled between an electronic device 80 and a support 81. The electronic device 80 can be a computer monitor containing a mounting interface at its back side where mounting holes 801 are located. Support 81 is a monitor stand containing a mounting plate 811, on which mounting holes 812 are provided. The device 1 is coupled with the electronic device 80 and the support 81 by screw couplings through the mounting holes 812, 41, 42, 801. Accessories can be mounted to the device 1 and supported by the device 1 and thus by the support 81.

The connection and support device can be an accessory mounting solution. The device may be used for video and/or audio related accessories such as LED lights, microphones and cameras. The device may support a variety of attachment threads such as ¼, ⅜ and ⅝ sizes commonly used for typical tripod-mounted devices.

The connection and support device does away with the need for regular table or floor mounted tripods or mounting arm solutions for each external device by directly attaching such devices to the back of a computer monitor through its standardized VESA mounting holes. Furthermore, it may allow multiple accessories to be mounted on a location selected from the top, the left side, or the right side, the bottom side, and a combination thereof of the connection and support device.

In some embodiments of the present invention, the coupling between the connection and support device with external devices and extension members may not involve any electronical circuitry. This creates the benefit of versatility as all tripod components are mainly mounting components that may allow convenient mounting and dismounting. Having cables laid on the outside of extension members, for example lighting attachments, but not having them integrated into the extension members may allow non-proprietary mounting components be used, such as thread adapters, ball-heads, double-ball heads, magic arms, etc., which provide significant enhanced versatility and user experience.

Non-limiting embodiments of the invention:
1. A connection and support device, including a main body including: a front surface of the main body; a back surface of the main body, the back surface being opposite to and parallel to the front surface; four sides including: a left side disposed between the front surface and the back surface, and where the left side is perpendicular to the front surface and the back surface; a top side disposed between the front surface and the back surface and where the top side is perpendicular to the front surface and the back surface, and where the top side is perpendicular to the left side; a right side disposed between the front surface and the back surface and perpendicular to the front surface and the back surface, and where the right side is perpendicular to the top side; and a bottom side disposed between the front surface and the back surface and perpendicular to the front surface and the back surface, and where the bottom side is perpendicular to the right side; and a plurality of openings at a location selected from the group consisting of the left side, the top side, the right side, the bottom side, and a combination thereof, each of the plurality of openings is adapted to accommodate an extension member.
2. The connection and support device according to embodiment 1, where each opening has a bore alignment, and where the bore alignment of at least one of the plurality of openings is tilted with an angle compared with the bore alignment of at least one other opening.
3. The connection and support device according to any one of embodiments 1 and 2, where the location is the left side, the top side, and the right side, and where each location comprises a plurality of openings.
4. The connection and support device according to any one of embodiments 1 to 3, where the location further comprises a recess, and where the recess comprises an opening.
5. The connection and support device according to any one of embodiments 1 to 4, where the recess comprises a primary slanted portion; the primary slanted portion is arranged to be inclined from the side where the recess is located; the opening is provided on the primary slanted portion such that the bore alignment of the opening is tilted with an angle compared with the side where the recess is located.
6. The connection and support device according to any one of embodiments 1 to 5, wherein the recess includes a secondary slanted portion, where the angle between the primary slanted portion and the side where the recess is located is smaller than the angle between the secondary slanted portion and the side.
7. The connection and support device according to any one of embodiments 1 to 6,where the angle between the primary slanted portion and the side where the recess is located is from about 5° to about 60°, or from about 15° to about 35°, or from about 20° to about 30°, or about 21°, or about 22°, or about 23°, or about 24°, or about 25°, or about 26°, or about 27°, or about 28°, or about 29°, or about 30°.
8. The connection and support device according to any one of embodiments 1 to 7, where the left side comprises an opening, the right side includes an opening, and where the bore alignments of the openings are collinear.
9. The connection and support device according to any one of embodiments 1 to 8, including from about three to about ten openings on a side.
10. The connection and support device according to any one of embodiments 1 to 9, where the bore alignment of each of the openings is different.
11. The connection and support device according to any one of embodiments 1 to 10, where the bore alignment is adjustable.
12. The connection and support device according to any one of embodiments 1 to 11, including about three openings on each of the four sides, and where the bore alignment of each of the three openings on each of the four sides is different.
13. The connection and support device according to any one of embodiments 1 to 12, where each of the left side and the right side includes two or three openings, where the bore alignments of the two or three openings are parallel to one another.
14. The connection and support device according to any one of embodiments 1 to 13, where the location includes two recesses.
15. The connection and support device according to any one of embodiments 1 to 14, where the location is the top side.
16. The connection and support device according to any one of embodiments 1 to 15, where one of the two recesses is located proximal to the left side and distant from the right side and the other of the two recesses is located proximal to the right side and distant from the left side.
17. The connection and support device according to any one of embodiments 1 to 16, the location is a side that comprises three openings, where one of the three openings is the middle opening located between the other two openings and oriented perpendicular to the side where it is located, and where the other two openings are oriented away from the middle opening as observed externally to the device.
18. The connection and support device according to any one of embodiments 1 to 17, where the device comprises a plurality of mounting holes for connecting the device with an apparatus and a support.
19. The connection and support device according to any one of embodiments 1 to 18, where the location is the top side and the bottom side, each of which comprises two recesses, where two recesses of the four recesses, one located at the top side and the other located at the bottom side, are proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, where the plurality of mounting holes are provided at the corner portions.
20. The connection and support device according to any one of embodiments 1 to 19, where the plurality of mounting holes comprise four 100 mm×100 mm spaced mounting holes and four 75 mm×75 mm spaced mounting holes, where each of the 75 mm×75 mm spaced mounting holes is located proximal to a mounting hole from the 100 mm×100 mm spaced mounting holes and is arranged in a radial direction closer to the center of the main body with respect to the 100 mm×100 mm spaced mounting hole.
21. The connection and support device according to any one of embodiments 1 to 20, where the location is the top side and the bottom side, each of which comprises two recesses, where the two recesses of the four recesses, one located at the top side and the other located at the bottom side, are located proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, wherein one or more mounting holes are provided at the corner portions, where the main body is substantially in form of a ring structure with the one or more corner portions attached to its outer side, where the 100 mm×100 mm spaced mounting holes are located at the corner portions and the 75 mm×75 mm spaced mounting holes are located at the ring structure.
22. The connection and support device according to any one of the any one of embodiments 1 to 21, where the connection and support device includes a central cavity in the middle of the main body.
23. The connection and support device according to any one of embodiments 1 to 22, the main body is substantially in form of a square prism with a length of from about 105 mm to about 150 mm, or from about 110 mm to about 120 mm, or about 110 mm, or about 115 mm, or about 120 mm, and a thickness of from about 7 mm to about 40 mm, or from about 10 mm to about 30 mm, or from about 15 mm to about 25 mm, or about 15 mm, or about 20 mm, or about 25 mm, and the central cavity is in form of a cylinder with circular bases formed on the front surface and the back surface, where the diameters of the circular bases are from about 60 mm to about 90 mm, or from about 80 mm to about 86 mm, or about 80 mm, or about 81 mm, or about 82 mm, or about 83 mm, or about 84 mm, or about 85 mm, or about 86 mm.
24. A connection and support device containing a main body having: a front surface of the main body; a back surface of the main body, the back surface being opposite to and parallel to the front surface; four sides includes: a left side disposed between the front surface and the back surface, and where the left side is perpendicular to the front surface and the back surface; a top side disposed between the front surface and the back surface and where the top side is perpendicular to the front surface and the back surface, and where the top side is perpendicular to the left side; a right side disposed between the front surface and the back surface and perpendicular to the front surface and the back surface, and where the right side is perpendicular to the top side; a bottom side disposed between the front surface and the back surface and perpendicular to the front surface and the back surface, and where the bottom side is perpendicular to the right side; where a plurality of openings at a location selected from the group consisting of the left side, the top side, the right side, the bottom side, and a combination thereof, each of the plurality of openings is adapted to accommodate an extension member; each opening has a bore alignment, and where at least one of the plurality of openings is tilted at a different angle compared with at least one other opening; where the bore alignment of each of the openings is different; where the bore alignment is adjustable; the location is the left side, the top side, and the right side, and where each location comprises a plurality of openings; the location further includes a recess, and where the recess includes an opening; the left side includes an opening, the right side includes an opening, and where the bore alignments of the openings are collinear; the main body is in form of rectangular shape; the four sides are provided at the main body substantially perpendicular to the front surface and the back surface; the device includes a central cavity in the middle of the main body so that the front surface and the back surface are communicated through the cavity portion, and the openings are exposed in the cavity; the device includes from about three to about ten openings on a side; in particular the device includes about three openings on each of the four sides, and where the bore alignment of each of the three openings on each of the four sides is different; the middle opening of the three openings is oriented in a way perpendicular to the surface where it is located; the left and right openings of the three openings are oriented away from the middle opening as observed externally to the device.
25. A method for connecting a connection and support device according to any one of embodiments 1 to 24 with an apparatus and a support, where the device having a main body including a plurality of mounting holes, the plurality of mounting holes including a first series of mounting holes and a second series of mounting holes, where each of the mounting holes from the second series of mounting holes is located proximal to a mounting hole from the first series of mounting holes and is arranged in a radial direction and closer to the center of main body with respect to the mounting hole from the first series of mounting holes, where the support includes a plurality of mounting holes corresponding to the first series of mounting holes and the second series of mounting holes, where the apparatus includes a plurality of mounting holes corresponding to either one of the first series of mounting holes or the second series of mounting holes, wherein method including the steps of a) connecting the device with the support, by a set of mounting members engaging with either the first series of mounting holes or the second series of mounting holes and the corresponding mounting holes on the support, such that the back surface of the main body is facing the support, b) connecting the device and the support to the apparatus, by another set of mounting members engaging with the other series of the first series of mounting holes and the second series of mounting holes, the corresponding mounting holes on the support, and the plurality of mounting holes on the apparatus, such that the front surface of the main body is facing the apparatus.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

1. A block for mounting accessories to a computer monitor, the monitor comprising a mounting interface with screw couplings disposed in a square array, the block comprising:
substantially parallel opposing surfaces, one of the surfaces adapted to abut the mounting interface, the opposing surfaces spaced apart in a through-thickness direction by a dimension defining a thickness of the block,
a periphery of the block extending between the two surfaces,
four first mounting apertures extending in the through-thickness direction between the two surfaces, the four first mounting apertures disposed in a first square array corresponding to the square array of the screw couplings,
a plurality of like openings in the periphery that are configured to receive mounting rods, each opening having an axis, the axis of each opening disposed in an imaginary plane parallel to the two surfaces,
the openings comprising a first pair of parallel openings for extending substantially horizontally in use, the openings of the first pair disposed adjacent one another on a first portion of the periphery,
the openings comprising a second pair of parallel openings for extending substantially horizontally in use, the openings of the second pair disposed adjacent one another on a second portion of the periphery substantially opposite the first portion of the periphery,
the openings comprising an orthogonal opening aligned substantially orthogonally to the first and second pairs of openings for extending substantially upwards from the block in use, the orthogonal opening disposed in an intermediate portion of the periphery, disposed between the first and second portions, and uppermost in use.

2. The block of claim 1, further comprising a central through-extending cavity that extends between the two surfaces such that the block has ring-like form, and each of the openings comprises an internal screw thread.

3. The block of claim 2, wherein the square array of the first four mounting apertures has a centre, the cavity is circular in cross-section and its axis passes through the centre, and further comprising four second mounting apertures extending in the through-thickness direction between the two surfaces, the four second mounting apertures disposed in a second square array smaller than the first square array and equidistant from the centre and angularly aligned with the four first mounting apertures.

4. The block of claim 1, wherein the openings further comprise a pair of acutely inclined openings in the intermediate portion of the periphery, wherein the acutely inclined opening are inclined acutely to the orthogonal opening and disposed on opposite sides of the orthogonal opening, the periphery includes respective circumferential faces surrounding the circumferences of the orthogonal opening and each of the acutely inclined openings, each of the circumferential faces aligned substantially perpendicular to respective axes of the openings.

5. The block of claim 4, wherein the intermediate portion of the periphery further comprises a respective concavity at least partially bounded by the respective circumferential faces around each of the acutely inclined openings.

6. A connection and support device including a main body comprising:
i. a front surface of the main body;
ii. a back surface of the main body, the back surface being opposite to and parallel to the front surface;
iii. four sides comprising:
a. a left side disposed between the front surface and the back surface, and wherein the left side is perpendicular to the front surface and the back surface;
b. a top side disposed between the front surface and the back surface and wherein the top side is perpendicular to the front surface and the back surface, and wherein the top side is perpendicular to the left side;
c. a right side disposed between the front surface and the back surface and perpendicular to the front surface and the back surface, and wherein the right side is perpendicular to the top side; and
d. a bottom side disposed between the front surface and the back surface and perpendicular to the front surface and the back surface, and wherein the bottom side is perpendicular to the right side; and
iv. the plurality of openings at a location selected from the group consisting of the left side, the top side, the right side, the bottom side, and a combination thereof, and each of the plurality of openings is adapted to accommodate an extension member.

7. The connection and support device according to claim 6, wherein each opening has a bore alignment, and wherein the bore alignment of at least one of the plurality of openings is tilted with an angle compared with the bore alignment of at least one other opening.

8. The connection and support device according to claim 6, wherein the location is the left side, the top side, and the right side, and wherein each location comprises a plurality of openings.

9. The connection and support device according to claim 6, wherein the location further comprises a recess, and wherein the recess comprises an opening.

10. The connection and support device according to claim 9, the recess comprises a primary slanted portion; the primary slanted portion is arranged to be inclined from the side where the recess is located; the opening is provided on the primary slanted portion such that the bore alignment of the opening is tilted with an angle compared with the side where the recess is located.

11. The connection and support device according to claim 10, wherein the recess includes a secondary slanted portion, where the angle between the primary slanted portion and the side where the recess is located is smaller than the angle between the secondary slanted portion and the side.

12. The connection and support device according to claim 11, wherein the angle between the primary slanted portion and the side where the recess is located is from about 5° to about 60°, or from about 15° to about 35°, or from about 20° to about 30°, or about 21°, or about 22°, or about 23°, or about 24°, or about 25°, or about 26°, or about 27°, or about 28°, or about 29°, or about 30°.

13. The connection and support device according to claim 6, wherein the left side comprises an opening, the right side comprises an opening, and wherein the bore alignments of the openings are collinear.

14. The connection and support device according to claim 6, comprising from about three to about ten openings on a side.

15. The connection and support device according to claim 6, wherein the bore alignment of each of the openings is different.

16. The connection and support device according to claim 6, wherein the bore alignment is adjustable.

17. The connection and support device according to claim 6, comprising about three openings on each of the four sides, and wherein the bore alignment of each of the three openings on each of the four sides is different.

18. The connection and support device according to claim 6, wherein each of the left side and the right side includes two or three openings, wherein the bore alignments of the two or three openings are parallel to one another.

19. The connection and support device according to claim 6, wherein the location includes two recesses.

20. The connection and support device according to claim 6, where the location is the top side.

21. The connection and support device according to claim 6, where one of the two recesses is located proximal to the left side and distant from the right side and the other of the two recesses is located proximal to the right side and distant from the left side.

22. The connection and support device according to claim 6, the location is a side that comprises three openings, where one of the three openings is the middle opening located between the other two openings and oriented perpendicular to the side where it is located, and where the other two openings are oriented away from the middle opening as observed externally to the device.

23. The connection and support device according to claim 6, where the device comprises a plurality of mounting holes for connecting the device with an apparatus and a support.

24. The connection and support device according to claim 23, where the location is the top side and the bottom side, each of which comprises two recesses, where two recesses of the four recesses, one located at the top side and the other located at the bottom side, are proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, where the plurality of mounting holes are provided at the corner portions.

25. The connection and support device according to claim 23, where the plurality of mounting holes comprise four 100 mm×100 mm spaced mounting holes and four 75 mm×75 mm spaced mounting holes, where each of the 75 mm×75 mm spaced mounting holes is located proximal to a mounting hole from the 100 mm×100 mm spaced mounting holes and is arranged in a radial direction closer to the center of the main body with respect to the 100 mm×100 mm spaced mounting hole.

26. The connection and support device according to claim 25, where the location is the top side and the bottom side, each of which comprises two recesses, where the two recesses of the four recesses, one located at the top side and the other located at the bottom side, are located proximal to the left side and distant from the right side, and the other two recesses, one located at the top side and the other located at the bottom side, are located proximal to the right side and distant from the left side, where four corner portions are formed between the left side and the recess located at the top side proximal to the left side, between the left side and the recess located at the bottom side proximal to the left side, between the right side and the recess located at the top side proximal to the right side, and between the right side and the recess located at the bottom side proximal to the right side, wherein one or more mounting holes are provided at the corner portions, where the main body is substantially in form of a ring structure with the one or more corner portions attached to its outer side, where the 100 mm×100 mm spaced mounting holes are located at the corner portions and the 75 mm×75 mm spaced mounting holes are located at the ring structure.

27. The connection and support device according to claim 6, wherein the connection and support device includes a central cavity in the middle of the main body.

28. The connection and support device according to claim 6, the main body is substantially in form of a square prism with a length of from about 105 mm to about 150 mm, or from about 110 mm to about 120 mm, or about 110 mm, or about 115 mm, or about 120 mm, and a thickness of from about 7 mm to about 40 mm, or from about 10 mm to about 30 mm, or from about 15 mm to about 25 mm, or about 15 mm, or about 20 mm, or about 25 mm, and the central cavity is in form of a cylinder with circular bases formed on the front surface and the back surface, where the diameters of the circular bases are from about 60 mm to about 90 mm, or from about 80 mm to about 86 mm, or about 80 mm, or about 81 mm, or about 82 mm, or about 83 mm, or about 84 mm, or about 85 mm, or about 86 mm.

29. An assembly for mounting accessories to a computer monitor, wherein the assembly comprises:
a block according to claim 1, and
one or more mounting rods for connecting the block or the connection and support device with the accessories,
wherein the one or more mounting rods and the accessories are supported by the block or the connection and support device.

30. The assembly according to claim 29, wherein the assembly further comprises a secondary hub, the secondary hub comprising:
a pair of first openings in parallel, each aligned with respective one of the first pair or the second pair of parallel openings of the block or aligned with respective one of the openings on left or right side of the connection and support device, each of the pair of the parallel openings of the secondary hub receiving one of the mounting rods, an end of the one of the mounting rods received by the respective one of the openings of the block or the connection and support device; and
a second opening for receiving another one of the mounting rods for coupling with one of the accessories.

31. The assembly according to claim 30, wherein the pair of the parallel openings of the secondary hub is located at a first side of the secondary hub facing the block or the connection and support device, and
the second opening of the secondary hub is located at a second side of the secondary hub, wherein first side and the second side of the secondary hub are perpendicular to each other, and the pair of the first openings of the secondary hub are perpendicular to the second opening of the secondary hub.

32. (canceled)

33. An assembly for mounting accessories to a computer monitor, wherein the assembly comprises:
a connection and support device according to claim 6, and
one or more mounting rods for connecting the block or the connection and support device with the accessories,
wherein the one or more mounting rods and the accessories are supported by the block or the connection and support device.
